(19) United States
(12) Patent Application Publication
(10) Pub. No.: US 2026/0003071 A1
(43) Pub. Date: Jan. 1, 2026

(54) Method of operating a radar according to a synthetic aperture imaging mode and a second operating mode using random phases and associated radar

(71) Applicant: THALES, Meudon (FR)

(72) Inventors: Philippe GOY, MERIGNAC (FR); Rodolphe COTTRON, MERIGNAC (FR); Stéphane KEMKEMIAN, MERIGNAC (FR)

(21) Appl. No.: 19/253,819

(22) Filed: Jun. 28, 2025

(30) Foreign Application Priority Data
Jun. 28, 2024 (FR) 2407047
Oct. 25, 2024 (FR) 2411687

(51) Int. Cl. G01S 13/90

(52) U.S. Cl. CPC G01S 13/904

(57) ABSTRACT

A method of operating a target detection radar following a first mode of operation and at least one second mode of operation, the first mode of operation being a synthetic aperture radar imaging mode and each second mode of operation being different from the first mode of operation, the method including the implementation of several recurrences of a signal emission/reception operation, wherein, for each N, the N^{th} recurrence of the operation including the following sub-operations: generation of a sequence of consecutive pulses, each pulse of the sequence being associated with a respective mode of operation, emission of the pulses in different frequency bands, and reception of the pulse echoes in a common time window, during the sub-operation of emission, at least one of the pulses, called the out of phase pulse, being emitted with a random phase associated with the number N.

### REFERENCE TO RELATED APPLICATIONS

This application is a U.S. non-provisional application claiming the benefit of French Patent Application No. 24 07047 filed on Jun. 28, 2024, and French Patent Application No. 24 11687 filed on Oct. 25, 2024, the contents of which are incorporated herein by reference in their entirety.

### TECHNICAL FIELD OF THE INVENTION

The present invention relates to a method of operating a detection and imaging radar. The present invention also relates to a detection and imaging radar implementing such a method.

The technical field of the invention is the management of the detection, imaging, and identification time budget by radar systems.

### BACKGROUND OF THE INVENTION

Traditionally, a radar system can be used in a “single-task” manner, that is, a single Doppler or non-Doppler mode of operation throughout the mission. This is, for example, the case of a maritime surveillance Doppler mode (known as “MMTI,” from the English “Maritime Moving Target Indicator”) or terrestrial (known as “GMTI,” from the English “Ground Moving Target Indicator”) which is adapted to a given altitude and type of target.

Thus, the AIR mode allows the detection of aircraft while the GMTI land surveillance mode allows the detection of devices moving on a land surface and the MMTI maritime surveillance mode allows the detection of devices moving on a maritime surface.

This adaptation includes, for example, the use of a fixed space scanning logic, waveforms, and processing. In other words, in such a case, the frame does not vary over time, as long as the operator does not change the mission or mode. The time budget is then associated only with this task and with the technical tasks of self-calibration of the radar.

For many years, radar operators have sought to expand the range of application of radar detection systems and sought for them to become “multitasking.” For example, for the same radar system, it is advantageous to simultaneously have a maritime tactical situation (MMTI), an aerial (known as “AIR”), and possibly have feedback on weather conditions. The radar system must then define the time budget to allocate to each of the tasks to be carried out.

Obviously, the more time allocated to a task, the more effective it will be, for example, in terms of detection and/or discrimination capacity. The management and optimization of the time budget thus appear crucial for new radar systems.

Traditionally, the radar system uses “short time” interleaving strategies (at the processing block scale) or “long time” (at the scanning scale) to carry out its different tasks. A time budget is allocated to each of these tasks based on a performance compromise of each function taken individually (refresh time, detection range, etc.).

The interleaving of radar blocks is then a technique that temporally schedules tasks that are not simultaneous.

To obtain simultaneous tasks, a known technique consists of breaking down the radar antenna system into several sub-networks and allocating a task to each of the sub-networks to perform what is called a colored emission. This operation is mainly found in MIMO-type radar systems (from the English “Multiple Input Multiple Output”).

The simultaneous emission of several orthogonal waveforms is thus carried out to color the space, that is, to associate a pair {sub-network, waveform} with a direction {azimuth-elevation}. The colored emission enables either obtaining a complete vision of the environment by significantly reducing or improving the refresh time of a task, or performing multiple tasks simultaneously.

This break down of the antenna space into sub-networks and the colored emission are not necessarily available or desirable for all radar architectures. Indeed, such a type of emission can degrade the performance of a radar system, particularly in terms of range.

### SUMMARY OF THE INVENTION

The present invention aims to solve this problem and therefore propose a solution allowing the implementation of a multitasking radar system while using a refresh time equivalent to that of a single-task system. This then allows adapting the radar system to multitasking combinations while preserving the system's performance.

To this end, a method of operating a target detection radar is described following a first mode of operation and at least one second mode of operation, the first mode of operation being a synthetic aperture radar imaging mode and each second mode of operation being different from the first mode of operation, the method including the implementation of several recurrences of a signal emission/reception operation, each N^{th} recurrence of the operation including the following sub-operations:
generation of a sequence of consecutive pulses, each pulse of the sequence being associated with the first mode of operation or the at least one second mode of operation,
emission of the pulses in different frequency bands, and
reception in a common time window of the echoes of the pulses, during the sub-operation of emission of each N^{th} recurrence, at least one of the pulses, called the de-phased pulse, being emitted with a random phase associated with the number N.

According to other advantageous aspects of the invention, the method includes one or more of the following features, taken individually or according to all technically possible combinations:
each pulse is emitted with a random phase associated with the corresponding frequency band.
the method further includes a preliminary operation of selecting a number M corresponding to a rank of ambiguity to be processed in a beam of signals emitted/received by the radar, the number M varying between 0 and a maximum number of ranks of ambiguity in the beam and wherein, during the sub-operation of reception of each N^{th} recurrence, the dephasing of the received echoes being compensated for the frequency band of the out of phase pulse, by the random phase associated with the number N−M.
the reception sub-operation includes the compensation of the dephasing of the received echoes in each frequency band by the random phase associated with the number N−M and this frequency band.
the pulses of each recurrence share the same frequency support and are emitted with a frequency gap greater than each of the frequency bands, the frequency gap is chosen to be able to distinguish the different frequency bands upon reception of the echoes.
during the generation operation, a pulse of the sequence is associated with the first mode of operation, each other pulse of the sequence being associated with a respective second mode of operation.
the sequence has a repetition frequency of between 1 kilohertz and 5 kilohertz.
the first mode of operation or the at least one second mode of operation corresponds to a given direction.
the first mode of operation or the at least one second mode of operation corresponds to a respective direction.

A method of operating a radar following a first mode of operation and at least one second mode of operation is also described, the first mode of operation being a synthetic aperture radar imaging mode and each second mode of operation being different from the first mode of operation, the method including the implementation of several recurrences of a signal emission/reception operation, each N^{th} recurrence of the operation including the following sub-operations:
generation of a sequence of consecutive pulses, each pulse of the sequence being associated with the first mode of operation or the at least one second mode of operation,
emission of the pulses in different frequency bands, the pulses associated with the first mode of operation and the at least one second mode of operation being emitted using different chirp slopes used to emit them, and
reception of the pulse echoes in a common time window.

According to other advantageous aspects of the invention, the method includes one or more of the following features, taken individually or according to all technically possible combinations:
during the reception sub-operation, echoes associated with the first mode of operation or the at least one second mode of operation are distinguished by determining the slopes of the corresponding chirps.
during the generation operation, a pulse of the sequence is associated with the first mode of operation, each other pulse of the sequence being associated with a respective second mode of operation.
the sequence has a repetition frequency of between 1 kilohertz and 5 kilohertz.
the second mode of operation is a Doppler mode.
the first mode of operation or the at least one second mode of operation corresponds to a given direction.
the first mode of operation or the at least one second mode of operation corresponds to a respective direction.

The description also describes a method of operating a radar following a first mode of operation and at least one second mode of operation, the first mode of operation being a synthetic aperture radar imaging mode and each second mode of operation being different from the first mode of operation, the method including the implementation of several recurrences of a signal emission/reception operation, each Nth recurrence of the operation including the following sub-operations:
generation of a sequence of consecutive pulses, each pulse of the sequence being associated with the first mode of operation or the at least one second mode of operation,
emission of the pulses in different frequency bands, the pulses associated with the first mode of operation and the at least one second mode of operation being emitted using different polarizations, and
reception of the pulse echoes in a common time window.

According to other advantageous aspects of the invention, the method includes one or more of the following features, taken individually or according to all technically possible combinations:
a polarization is emitted for each pulse.
a set of polarizations forming a signature is emitted for each pulse.
during the reception sub-operation, echoes associated with the first mode of operation or the at least one second mode of operation are distinguished by determining their polarizations.
during the generation operation, a pulse of the sequence is associated with the first mode of operation, each other pulse of the sequence being associated with a respective second mode of operation.
the sequence has a repetition frequency of between 1 kilohertz and 5 kilohertz.
the second mode of operation is a Doppler mode.
the first mode of operation or the at least one second mode of operation corresponds to a given direction.
the first mode of operation or the at least one second mode of operation corresponds to a respective direction.

The present description also includes a radar including technical means configured to implement one of the methods as defined above.

To this end, the invention includes a method of operating a target detection radar in clutter analysis mode following several detection configurations, each detection configuration corresponding to a different detection distance and the radar, the method including the implementation of several recurrences of a signal emission/reception operation, each N^{th} recurrence of the operation including the following sub-operations:
+generation of a sequence of consecutive pulses, each pulse of the sequence being associated with a respective detection configuration;
+emission of the pulses in different frequency bands;
+reception of the pulse echoes in a common time window.

According to other advantageous aspects of the invention, the method includes one or more of the following features, taken individually or according to all technically possible combinations:
the method further includes a preliminary operation of selecting a number M corresponding to a rank of ambiguity to be processed in a beam of signals emitted/received by the radar, the number M varying between 0 and a maximum number of ranks of ambiguity in the beam;
during the sub-operation of emission of each N^{th} recurrence, at least one of the pulses, called the out of phase pulse, being emitted with a random phase associated with the number N;
during the sub-operation of reception of each N^{th} recurrence, the dephasing of the reception of the echoes being compensated for the frequency band of the out of phase pulse by the random phase associated with the number N−M.
each pulse is emitted with a random phase associated with the corresponding frequency band.
the sub-operation of reception includes the compensation of the dephasing of the received echoes in each frequency band by the random phase associated with the number N−M and this frequency band.
the pulses of each recurrence share the same frequency support and are emitted with a frequency gap greater than each of the frequency bands.
the frequency gap is chosen to be able to distinguish the different frequency bands at the reception of the echoes.
the sequence includes a number greater than or equal to 2 pulses.
the different detection configurations correspond to different emission and reception directions.
the different emission and reception directions correspond to different angles, the angles being chosen from site angles defined relative to a pointing direction or azimuth angles defined relative to a pointing direction.
the method includes, after receiving the pulses of the sequence, an operation of implementing an emission and reception of an additional pulse, the implementation operation being repeated so that the number of additional pulses is equal to the number of pulses of the sequence.
the emission direction of each additional pulse is the same as that of a pulse of the sequence.
during the emission sub-operation, the pulses associated with different detection configurations are emitted using different chirp slopes used to emit them.
during the reception sub-operation, echoes associated with different detection configurations are distinguished by determining the slopes of the corresponding chirps.
during the emission sub-operation, the pulses associated with different detection configurations are emitted using different polarizations.
a polarization is emitted for each pulse.
a set of polarizations forming a signature is emitted for each pulse.
during the reception sub-operation, echoes associated with different detection configurations are distinguished by determining their polarizations.

The invention also includes a target detection radar including technical means configured to implement the method as defined above.

### BRIEF DESCRIPTION OF THE DRAWINGS

The invention will appear more clearly upon reading the following description, given solely by way of non-limiting example, and made with reference to the drawings wherein:

FIG. 1 is a schematic view of a radar according to the invention;

FIG. 2 is a flowchart of a method of operating the radar of FIG. 1; and

FIGS. 3-7 are different views illustrating the implementation of the method of FIG. 2.

### DETAILED DESCRIPTION OF THE INVENTION

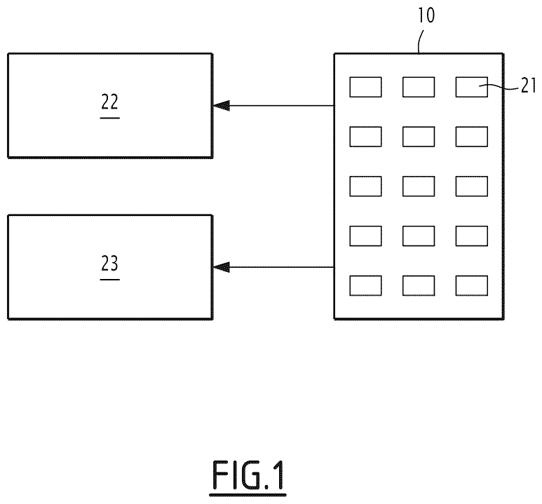

FIG. 1 illustrates a radar 10 according to the invention. This radar 10 is intended, for example, to be embarked on a mobile carrier moving in the air and/or on a terrestrial surface and/or on a maritime surface. Advantageously, the radar 10 is intended to be embarked on a carrier moving in the air, such as an aircraft. Alternatively, the radar 10 is arranged in a fixed manner.

The radar 10 allows detecting or characterizing targets according to several modes of operation.

A first mode of operation is the synthetic aperture radar imaging mode.

Synthetic aperture radar imaging is more often referred to by the acronym SAR referring to the English denomination “Synthetic Aperture Radar.”

SAR imaging is a radar technique allowing imaging the ground with excellent range resolution (inversely proportional to the emitted band) and excellent transverse resolution (inversely proportional to the illumination time).

To obtain metric or even sub-metric resolution images, the necessary illumination times exceed ten seconds depending on the radar carrier's speed values. In general, the radar sensor is then entirely dedicated to the ground imaging function.

The operator can command one or more areas to be imaged in two different ways.

In SPOTLIGHT operation, the operator selects one or more areas, for example, by indicating the coordinates (latitude, longitude) of the central points: the radar scheduler successively commands the waveforms and SAR processing sequentially for each area to be imaged as long as these areas are within the radar's visibility cone.

In STRIPMAP operation, the operator states the central point in {distance, azimuth} relative to the radar. As long as the command is active, the radar scheduler commands a succession of SAR illuminations around this central point, so as to have SAR images scrolling according to the carrier's speed.

In general, the radar sensor and associated processing are entirely devoted to the production of SAR images.

The repetition frequency ranges Fr of a SAR mode are on the order of 1 kHz to 5 kHz.

For a multi-panel radar, when the emission/reception architecture of several panels simultaneously is possible, simultaneous modes can be employed: one mode per panel.

The radar 10 is also capable of operating according to one or more second modes.

Each second mode of operation is different from the first mode of operation.

The second mode of operation has the same recurrence period as the first mode of operation.

According to a first example, the second mode of operation is a Doppler mode.

By definition, the Doppler mode of a radar corresponds to a mode of operation of the latter in which Doppler-type processing is applicable.

Such a second mode of operation is, for example, chosen from the list consisting of:
an active pursuit Doppler mode, and
a GMTI Doppler mode without resolving range-velocity ambiguity

More generally, the second mode of operation is any type of Doppler mode that can operate at the SAR mode repetition frequency.

According to a second example, the second mode of operation is a non-Doppler mode.

By way of illustration, the non-Doppler second mode of operation is then chosen from the list consisting of:
an MTO mode,
a maritime detection mode, and.
a Look up type mode without the need to reject ground clutter by Doppler processing.

More generally, the second mode of operation is any type of Doppler mode that can operate at the SAR mode repetition frequency.

According to another mode of operation, the SAR mode repetition frequency can vary within the image acquisition to make it possible to operate a Doppler mode, GMTI for example, with range-velocity ambiguity resolution.

Furthermore, in the case of the present application with common reception, each mode of operation is performed on the same antenna panel on the same visibility cone of the antenna.

Referring to FIG. 1, the radar 10 includes an array of elementary antennas 21 allowing emitting signals in the form of pulses and receiving signals corresponding to echoes of these pulses.

The radar 10 further includes an emission unit 22 allowing generating the pulses to be emitted by the antenna array 21 and a reception unit 23 allowing processing the echoes received by the antenna array 21 to deduce the presence of a target and possibly, a speed and a distance to this target.

Each of the units 22, 23 is made, for example, in the form of a programmable circuit of the FPGA type (from the English “Field Programmable Gate Array”) and/or of the ASIC type (from the English “Application-Specific Integrated Circuit”). In addition, or alternatively, each of these units 22, 23 is made at least partially in the form of software executable by a processor and stored in a memory.

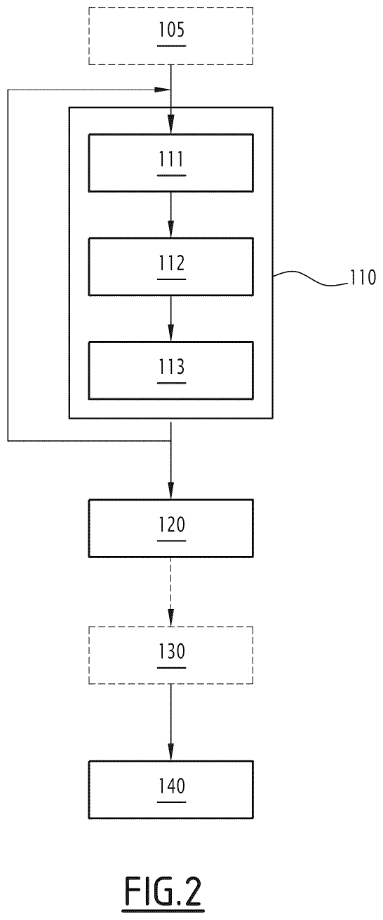

The method of operating the radar 10 will now be explained with reference to FIG. 2 presenting a flowchart of its operations.

It is considered that this method is implemented to perform a scan or an image of the surroundings of the carrier embarking the radar 10, according to, for example, a direction of movement of the carrier.

This method notably includes the implementation of several recurrences of a signal emission/reception operation 110.

The repetition frequency of these recurrences is chosen based on repetition frequencies associated with the first mode of operation (SAR mode).

Each N^{th} recurrence of operation 110 includes the implementation of sub-operations 111 to 113 explained in detail below.

During sub-operation 111, the emission unit 22 generates a sequence of at least two consecutive pulses associated with a respective mode of operation.

In particular, during this sub-operation, the emission unit 22 generates a first pulse I₁ associated with the first mode of operation and a second pulse I₂ associated with the second mode of operation.

Each pulse is associated with an emission and reception direction defined, for example, by a pair of angular values. These angular values correspond, for example, to the elevation (or site) and azimuth of emission, denoted hereafter respectively by Elᵢ and Azᵢ. The emission of each pulse is oriented according to these angular values thanks to a conventional beamforming (FFC) performed at the emission. In all that follows, the index i=1 designates the first mode of operation of radar 10 and i=2 designates the second mode of operation of radar 10.

The pulses are generated in an emission window Te wherein each pulse has a width Li and is spaced from the other pulse and from one of the boundaries of the emission window Te by a time gap T_{GAP}.

It can be noted here that the pulse widths can be of different widths without loss of generality.

Advantageously, in the following, it is assumed that Li1=Li2, this corresponding to an easier implementation.

In the frequency domain, the pulses share the same frequency support of receiving B_{rec}, with a frequency gap F_{GAP} between the corresponding carriers Fi greater than the frequency bands Bi of these pulses. The frequency gap F_{GAP} is chosen sufficient to distinguish the echoes of these pulses at reception. In all that follows, a frequency band is defined by a central frequency and a bandwidth.

Without loss of generality, the frequency bands can be of different widths between the two modes.

Advantageously, in the following, all frequency bands have the same width.

The frequency band B₁ of the first pulse I₁, that is, the pulse associated with the first detection configuration, is chosen the same for each recurrence.

Advantageously, this choice is independent of the application of radar 10.

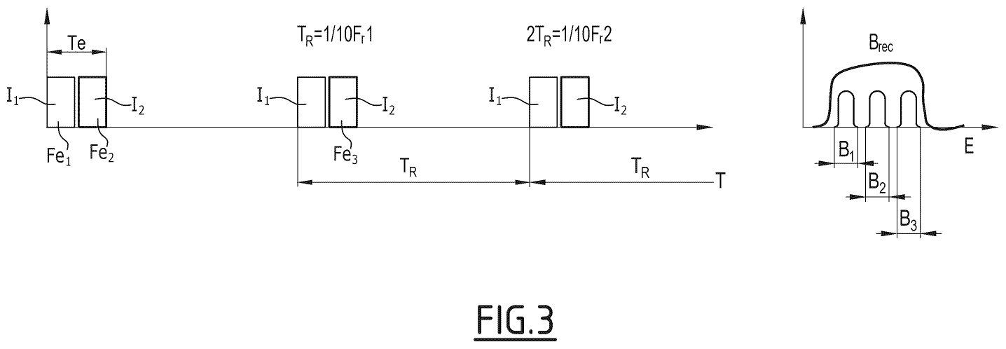

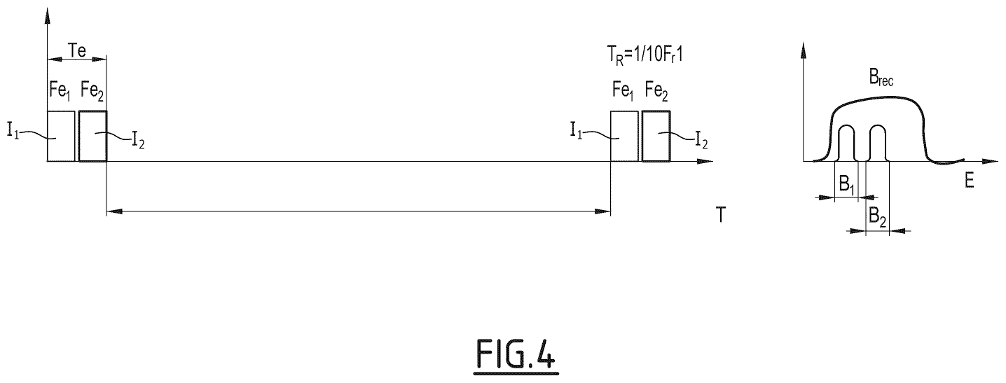

This is schematically illustrated in FIGS. 3 and 4 illustrating several consecutive recurrences corresponding to two distinct applications of radar 10. Thus, the same central frequency Fe₁ is chosen for the first pulse in each recurrence in each application to be able to perform coherent processing on the pulse train associated with pulse I1, frequency Fe₁, and direction (Az₁,El₁).

The frequency band of the second pulse I₂, that is, the pulse associated with the second detection configuration, is chosen based on the application of radar 10.

In particular, for a first variant of operation, the same frequency band and more particularly the same central frequency for the second pulse I₂ is chosen in each k^{th} recurrence. This technique can be seen as a barrel mechanism, where at each instant T_{R}, a central frequency is chosen in the barrel modulo k. In other words, in such a case, k different central frequencies are alternately chosen for the second pulses I₂ in k consecutive recurrences.

In the example of FIG. 3, when k=2, two frequency bands B₂ and B₃ (that is, two central frequencies) are then alternately chosen for each second pulse I₂.

For a second variant, the same frequency band B₂ for the second pulse I₂ is chosen in each recurrence, as illustrated in FIG. 4.

During sub-operation 112, the emission unit 22 emits the pulses generated during the previous sub-operation in the corresponding frequency bands.

During sub-operation 113, the reception unit 23 receives echoes corresponding to the emitted pulses in a common reception time window. The duration of this common reception window is equal to the total duration of the recurrence TR minus the duration of the emission window Te.

During reception, the echoes corresponding to different pulses are distinguished by their different frequency bands, using, for example, band-pass filters.

A spatial filtering in reception of the FFC type is applied in the direction of the emitted pulses to separate the echoes from the different emitted pulses. This FFC in reception can be performed identically or differently from that performed in emission (different weighting in particular).

During a subsequent operation 120, implemented after the N recurrences of operation 110, the reception unit 23 implements a coherent processing of the echoes corresponding to the pulses associated with the first detection configuration and the pulses associated with the second detection configuration. Such coherent processing consists of applying the filtering adapted to the waveform of the desired configuration, for example, a pulse compression on the short time axis (within a recurrence) and a Doppler processing combining the signals of each recurrence sharing the same emission frequency.

During a subsequent operation 130, implemented only when radar 10 operates according to its first variant, the reception unit 23 further implements a non-coherent processing at the outputs of the coherent processing of the pulses associated with the second mode of operation. Such non-coherent processing performs the power averaging of the signals received on each frequency band of the same direction (after the coherent processing).

By way of remark, it may be noted here that only the non-coherent processing is implemented for a non-Doppler processing.

In some embodiments, this operation is implemented systematically (i.e., regardless of the radar application) as long as k=1 the average is directly the signal.

During a subsequent operation 140, the reception unit 23 transmits all the outputs of the coherent processing and possibly the non-coherent processing, to any interested system allowing, for example, to implement a detection operation, a range and/or speed ambiguity resolution.

These outputs can then be used to detect one or more targets according to the different modes of operation, possibly with speeds and distances associated with these targets.

In some embodiments, the method of operation as explained above further includes the implementation of at least one additional technique allowing separating the echoes of the two modes, or even rejecting certain echoes that are not necessary or are ambiguous in range, to reconstruct a complete, necessary, and sufficient image of the radar surroundings according to at least one of the aforementioned modes of operation.

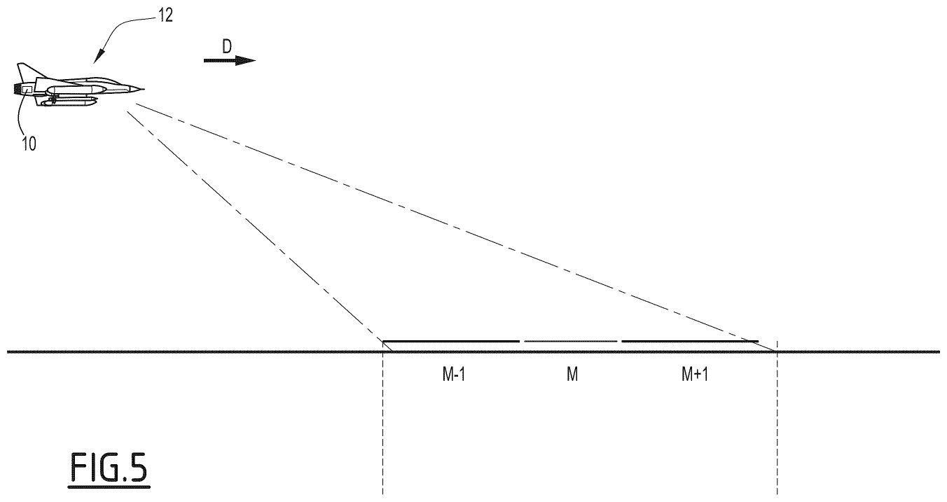

FIG. 5 illustrates an example of such a case allowing processing a single range ambiguity rank according to the SAR radar mode. According to this example, the radar beam emitted by radar 10 from carrier 12 covers on the terrestrial surface several portions whose echoes overlap by range ambiguity related to the choice of the repetition frequency Fr of the mode. To avoid processing all the echoes coming from the beam footprint on the ground, a first technique consisting of choosing only one ambiguity rank within the beam is implemented, this range zone constituting the entire area of interest of the mode (SAR or GMTI).

According to this first separation technique, the method of operation of radar 10 further includes a preliminary operation 105 consisting of selecting a number M corresponding to an ambiguity rank to be processed in the beam of signals emitted/received by the radar. This number M then varies between 0 and a maximum number of ranks of ambiguity in the beam. The maximum number depends in particular on the radar beam's aperture. As illustrated in FIG. 5, the ambiguity rank M can correspond to the central part of the radar beam.

In some embodiments, during this operation, several numbers M corresponding to several ambiguity ranks to be processed are chosen, i.e., when the mode's area of interest is spread over several range ambiguity ranks. In this case, it is considered hereafter that the technique described below is applied in relation to each chosen number M. The processing is performed, for example, in parallel.

During the implementation of the N^{th} recurrence of operation 110 and notably during the emission sub-operation 112, the emission unit 22 chooses one of the pulses associated with one of the radar modes, for example, the first pulse and adds a random phase ϕ_{iN} to this pulse. Advantageously, the emission unit 22 adds a different random phase ϕ_{iN} to each of the pulses. Each pulse having a random phase ϕ_{iN} added is hereafter called an out of phase pulse.

It should be noted that the choice of out of phase pulse can remain the same for each recurrence of this sub-operation 112. In other words, when only one pulse is out of phase during this sub-operation, the same pulse is out of phase in each recurrence of this operation. When both pulses are out of phase during this sub-operation, these pulses are also out of phase in each recurrence of this sub-operation.

It should also be noted that the value of the random phase ϕ_{iN} for the or each pulse is then memorized for all the recurrences, i.e., N+M subsequent recurrences of operation 110.

Then, during the reception sub-operation 113, the reception unit 23 compensates the dephasing of the received echoes in the frequency band of the or each out of phase pulse, by the random phase associated with the number N−M. In other words, the dephasing is performed by subtracting the value ϕ_{iN-M} in the band corresponding to index i.

Thus, during the subsequent processing, only the echoes corresponding to the ambiguity rank M can be processed coherently. The dephasing of the other echoes cannot be done correctly so that they will behave like white noise.

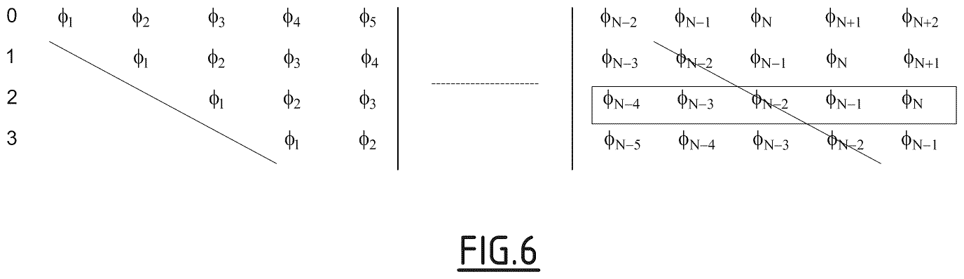

This principle is schematically illustrated in FIG. 6. According to the example of this figure, the number M is equal to 2 and the maximum number of ambiguity ranks is equal to 3. Thus, during the Nth recurrence of operation 110, to choose only the signals corresponding to the ambiguity rank M=2, the value ϕ_{iN-2} is used to compensate the dephasing of the recurrence N in the corresponding frequency band.

In other words, this random phase compensation and then the coherent processing on the N+M recurrences constitute the filtering adapted to the out of phase pulse.

Other techniques for resolving range and speed ambiguities and/or according to at least one pointing direction are also possible, for example, by using several repetition frequencies associated with an extraction processing.

Furthermore, it is also possible to obtain better isolation of the echoes corresponding to different radar modes during their reception.

Thus, according to a second separation technique, during the implementation of the N^{th} recurrence of operation 110 and notably during the emission sub-operation 112, the emission unit 22 implements different chirp slopes used to emit the pulses associated with different detection configurations.

In other words, during this sub-operation 112, the emission unit 22 emits the pulses using either an ascending slope or a descending slope depending on the configuration associated with each pulse. The same slope is then used for all pulses of this type in all recurrences of operation 110.

For example, for all recurrences, an ascending slope is chosen for the pulses associated with the first configuration and a descending slope is chosen for the pulses associated with the second configuration.

Then, during the reception sub-operation 113, the reception unit 23 receives echoes having different frequency slopes. This reception unit 23 therefore determines the received slopes to isolate the echoes corresponding to different detection configurations.

For this, the reception unit 23 employs filters (pulse compression) adapted to the corresponding chirp slopes.

According to a third separation technique allowing also obtaining better isolation of the echoes corresponding to different radar modes during their reception, during the implementation of the N^{th} recurrence of operation 110 and notably during the emission sub-operation 112, the emission unit 22 implements different polarizations of the waves used to emit the pulses associated with different radar modes.

In other words, during this sub-operation 112, the emission unit 22 emits the wave carrying each pulse with a polarization chosen based on the radar mode associated with this pulse. This same polarization is chosen for this type of pulse for all recurrences of operation 110.

For example, two polarizations, namely a vertical polarization and a horizontal polarization can be chosen for the pulses emitted during the emission sub-operation 112.

According to other examples, a 45° or circular polarization can be used. For example, a left circular polarization can be associated with the first configuration and a right circular polarization can be associated with the second configuration.

Then, during the reception sub-operation 113, the reception unit 23 receives echoes having different polarizations. This reception unit 23 therefore determines the received slopes to isolate the echoes corresponding to different configurations.

For this, the reception unit 23 employs filters adapted to the corresponding polarization slopes.

The principle just described can be refined by using several polarizations in the same pulse.

In such a case, each pulse includes a specific polarization signature. Such a signature corresponds to a polarization code.

This technique thus allows coloring the different pulses in space and obtaining an additional rejection of 20 to 30 dB.

In some embodiments, the aforementioned techniques are combined with each other to be implemented simultaneously. In addition, a technique for resolving range and speed ambiguities and/or according to at least one pointing direction can also be used in combination with the second technique or the third technique, as described above.

It is then understood that the present invention presents a number of advantages.

The method consists of taking advantage of the emission/reception time of a first SAR imaging mode of operation to perform one (or more) other radar tasks (second mode of operation) on the same antenna panel.

The radar scheduler can test for each of the active or inactive tracks in the common visibility cone to the SAR image the active tracks compatible for the detection of the SAR mode Fr: the tracks are the to be compatible when they fall in a “clear” zone of the SAR waveform, that is, outside range eclipse, in thermal noise zone, and outside ground clutter eclipse (for example, ˜+/−10 m/s modulo the ambiguous speed=λFr/2).

The scheduler then periodically takes active tracking points at the same time as the SAR at the pulse scale.

The fact of using a single Tr prohibits ambiguity resolution, which is not a problem in active pursuit because the non-ambiguous speed and distance of the tracks are already known.

Alternatively, it is conceivable to provide the user with an automatic adjustment possibility on the Fr also on the SAR mode to be able to perform an ambiguity resolution for the associated Doppler mode (GMTI, unnecessary in active pursuit).

This nevertheless assumes maintaining phase coherence for the SAR, thus remaining at a constant Fe.

According to an example, to respect this constraint, the signal feeding the SAR can be resampled to return to a situation where the Fr is constant. The SAR acquisition window being dynamic and the range to be imaged being predefined, a value of Li and Fr can be chosen to take into account the eclipse phenomenon occurring with the range.

In each of the previously described embodiments, the method thus allows benefiting from the same information with a gain in speed.

According to advantageous embodiments, it is possible to reduce the margin taken on the clutter-to-noise ratio of SAR image construction by dividing the emission time into P sub-pulses: one of the sub-pulses is associated with the SAR imaging mode and the other sub-pulses are associated with one (or more) second mode(s), which can, in a particular case, correspond to another SAR image taken over another region.

It is also possible to implement an operation frequency technique.

The operation frequency technique is more often referred to by the corresponding English term “operation frequency.”

This operation frequency technique is a classic SAR technique that allows recombining emitted bands to have a range resolution equivalent to a very large synthetic band. An example of implementation is known from the application FR 2766578 B.

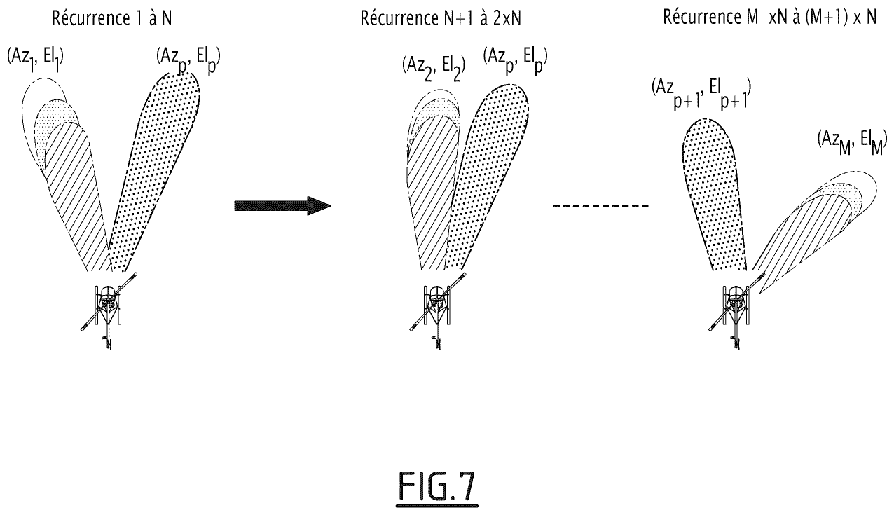

A radar 10 operation can also be highlighted with reference to FIG. 7, wherein the first mode of operation or the at least one second mode of operation corresponds to a respective direction.

In this case, the recurrence period Tr is common on the waveforms, but the pointed directions are decorrelated.

1. A method of operating a target detection radar following a first mode of operation and at least one second mode of operation, the first mode of operation being a synthetic aperture radar imaging mode and each second mode of operation being different from the first mode of operation, the method comprising several recurrences of signal emission/reception, wherein for each N, the N^{th} recurrence comprises:
generating a sequence of consecutive pulses, each pulse of the sequence being associated with the first mode of operation or the at least one second mode of operation;
emitting the pulses in different frequency bands, wherein at least one of the pulses, called the out of phase pulse, is emitted with a random phase associated with the number N; and
receiving in a common time window echoes of the pulses.

2. The method according to claim 1, wherein each pulse is emitted with a random phase associated with the corresponding frequency band.

3. The method according to claim 2, further comprising:
selecting a number M corresponding to an ambiguity rank to be processed in a beam of signals emitted/received by the radar, the number M varying between 0 and a maximum number of ambiguity ranks in the beam; and
during said receiving, compensating the dephasing of the received echoes for the frequency band of the out of phase pulse, by the random phase associated with the number N−M.

4. The method according to claim 3, wherein said receiving comprises compensating the dephasing of the received echoes in each frequency band, by the random phase associated with the number N−M and the frequency band.

5. The method according to claim 1, wherein the pulses of each recurrence share the same frequency support and are emitted with a frequency gap greater than each of the frequency bands, and wherein the frequency gap is chosen to be able to distinguish the different frequency bands at the reception of the echoes.

6. The method according to claim 1, wherein during said generation, a pulse of the sequence is associated with the first mode of operation, and each other pulse of the sequence is associated with a respective second mode of operation.

7. The method according to claim 1, wherein the sequence has a repetition frequency between 1 kilohertz and 5 kilohertz.

8. The method according to claim 1, wherein the first mode of operation or the at least one second mode of operation corresponds to a given direction.

9. The method according to claim 1, wherein the first mode of operation or the at least one second mode of operation corresponds to a respective direction.

10. A radar implementing the method according to claim 1.
